(19) United States
(12) Patent Application Publication
(10) Pub. No.: US 2008/0141290 A1
(43) Pub. Date: Jun. 12, 2008

(54) Automatic balancing apparatus, rotative apparatus and disc drive

(75) Inventors: Yuji Shishido, Kanagawa (JP); Takashi Mochida, Chiba (JP); Yoshihiro Abe, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/107,724

(22) Filed: Apr. 18, 2005

(30) Foreign Application Priority Data
Apr. 19, 2004 (JP) 2004-123168
Feb. 16, 2005 (JP) 2005-039496

(51) Int. Cl. G11B 33/08

(52) U.S. Cl. 720/651

(57) ABSTRACT

An automatic balancing apparatus includes a fluid balancer; a holding member for holding the balancer by generating a surface tension on the balancer; and a rotatably provided housing member housing the balancer and the holding member so that the balancer held by the holding member on its inner circumferential side moves toward an outer circumferential side of the housing member by centrifugal force caused by rotation.

### CROSS REFERENCE TO RELATED APPLICATIONS

The present invention contains subject matter related to Japanese Patent Applications JP2004-123168 and JP2005-039496, filed to the Japanese Patent Office respectively on Apr. 19, 2004 and Feb. 16, 2005, the entire contents of which being incorporated herein by reference.

### BACKGROUND OF THE INVENTION

1. Field of the Invention

The present invention relates to an automatic balancing apparatus for maintaining balance of rotation, a rotative apparatus equipped with such automatic balancing apparatus, and a disc drive equipped with such automatic balancing apparatus.

2. Description of Related Art

In recent years, it has been known that in a disc drive such as an optical disc drive or a magnetic disc drive for recording and reproducing data, rotation of the disc becomes unbalanced during rotation of the disc on a turntable, so that the stability of recording and reproduction decreases.

In Patent Document 1 (Japanese Patent Publication No. 2824250 (Paragraph [0026], FIGS. 1 and 6), technology has been disclosed for improving the balance of rotation of discs, in which an automatic balancing apparatus is incorporated into a disc drive. This disc drive has a motor for rotating a disc. This motor is supported by a subchassis, and the subchassis is supported on a main chassis by means of elastic members. The automatic balancing apparatus includes a clamper for clamping discs, and this clamper has a ring-shaped hollow section in which a balancer such as a plurality of steel balls or a liquid is movably housed. In this configuration, during the rotation of a disc, the steel balls or the liquid are moved in a direction approximately opposite to the direction of deviation of the rotation center of the disc, thereby improving the balance of rotation.

In Patent Document 2 (Japanese Patent Application Laid-Open No. HEI4-312244 (Paragraph [0006], FIG. 1)), another technology has been disclosed for improving the balance of rotation of discs, in which a disk-shaped member having a space or chamber in which a magnetic fluid can be housed is provided so as to integrally rotate with a motor shaft. The disk-shaped member has a boss section, and a ring magnet is provided on the peripheral lateral surface of the boss section. In this configuration, when the rotation speed of the rotation shaft is low, the magnetic fluid is attracted to the ring magnet so as to prevent a disc from losing the balance of rotation.

### SUMMARY OF THE INVENTION

However, in general, the amplitude of vibration during the rotation of a disc is small, and it is difficult to gain large force for maintaining the balance of rotation of the disc by means of a balancer. Accordingly, a balanced state of the disc is difficult to ensure with small amplitude of vibration. For example, while water of mass m (=1 g) rotates with eccentricity e (=0.1 mm) at a rotation radius r (=15 mm), an approximate value C (=me) of the capability to improve the balance of rotation is 0.1 (g·mm). With this value, it is difficult to improve the balance of rotation of a DVD (Digital Versatile Disc) having a diameter of 12 cm, for example.

In addition, if the steel balls or the liquid move by centrifugal force in a direction approximately opposite to the direction of deviation of the rotation center of the disc, there occurs the problem that the steel balls or the liquid flow along the outer circumference of the ring-shaped hollow section, so that the deviation of the steel balls or the liquid disappears and the balance of rotation of the disc becomes difficult to improve. In the art disclosed in Patent Document 2, when a disc drive is located in a vertical state, i.e., the recording surface of a disc is located perpendicularly to the ground, for example, the magnetic fluid accumulated in a bottom section of the disk-shaped member is difficult to return toward the ring magnet. This leads to the problem that when the disc drive is positioned in certain attitudes, it is difficult to ensure the balance of rotation of the disc.

The present invention has been conceived in view of the above-mentioned issues, and intends to provide an automatic balancing apparatus capable of improving the balance of rotation irrespective of attitudes, a rotative apparatus equipped with such automatic balancing apparatus, and a disc drive equipped with such automatic balancing apparatus.

An automatic balancing apparatus according to a preferred embodiment of the present invention includes a balancer made of a fluid, a holding member constructed to hold the balancer by generating surface tension in the balancer, and a housing member which is rotatably provided and in which the balancer and the holding member are housed so that the balancer held by the holding member on an inner circumferential side of the housing member is allowed to move toward an outer circumferential side of the housing member by centrifugal force due to rotation.

According to the preferred embodiment of the present invention, the automatic balancing apparatus includes the holding member, whereby the balancer can be held on the inner circumferential side of the holding member by using the surface tension irrespective of the attitude of the automatic balancing apparatus. Accordingly, the automatic balancing apparatus can start rotating with the balancer held by the holding member irrespective of the attitude of the automatic balancing apparatus, whereby the balance of rotation can be improved in a stable manner.

According to a preferred embodiment of the invention, the automatic balancing apparatus further includes a restrictive member provided on the outer circumferential side of the housing member and operative to restrict movement of the balancer in a circumferential direction when the housing member rotates. According to this preferred embodiment of the invention, the balancer is held on the inner circumferential side of the holding member irrespective of the attitude of the automatic balancing apparatus, and when the automatic balancing apparatus starts rotating, the restrictive member is prevented from hindering the movement of the balancer, whereby the automatic balancing apparatus can be made to rotate stably. In addition, when the automatic balancing apparatus rotates, the flow of the balancer along the internal surfaces of the housing member can be restricted by the restrictive member. Accordingly, even if the amplitude of vibration during the rotation of a disc is small, for example, the balanced state of rotation of the disc can be ensured by the balancer locally accumulated by the restrictive member according to the preferred embodiment of the present invention. In addition, it is possible to considerably improve the balance of rotation of the automatic balancing apparatus by efficiently using a small amount of balancer.

According to another preferred embodiment of the present invention, the holding member has a plurality of plates provided to be stacked at a predetermined interval in an axial direction of rotation. According to this configuration, surface tension may be efficiently generated in the balancer in gaps each formed by adjacent ones of the plates, so as to hold the balancer can be held. In addition, the capability of the holding member to hold the balancer may be further improved by increasing the number of the plates or reducing the gaps between the plates. Each of the gaps is preferably not larger than several hundred μm.

According to another preferred embodiment of the present invention, the holding member forms a flow path which is formed to become narrower from the outer circumferential side toward the inner circumferential side and through which to circulate the balancer. According to this configuration, the force of the holding member to suck the balancer by surface tension may be made larger from the outer circumferential side toward the inner circumferential side of the holding member, whereby the holding member can hold the balancer far more reliably. The term “to become narrower” or “narrow” means “to become stepwise or continuously narrower”. A case where the flow path becomes continuously narrower is a case where walls for the flow path are formed in tapered shapes, for example.

According to another preferred embodiment of the present invention, the flow path is formed to have a width in a rotation axis direction in which the housing member rotates, which width is formed to become narrower from the outer circumferential side toward the inner circumferential side. According to this configuration, the force of the holding member to suck the balancer by surface tension from the outer circumferential side toward the inner circumferential side of the holding member can be made large, whereby the holding member may hold the balancer far more reliably.

According to another preferred embodiment of the present invention, the flow path is formed to have a width in a rotation perimeter direction in which the housing member rotates, which width is formed to become narrower from the outer circumferential side toward the inner circumferential side. According to this configuration, the force of the holding member to suck the balancer by surface tension from the outer circumferential side toward the inner circumferential side of the holding member can be made large, whereby the holding member may hold the balancer far more reliably.

According to another preferred embodiment of the present invention, the automatic balancing apparatus further includes a permanent magnet provided on the inner circumferential side of the housing member, and the balancer is magnetized. According to this configuration, the balancer can be held on the holding member not only by the surface tension of the balancer but also by magnetic force. Accordingly, the capability of the holding member to hold the balancer may be improved to improve the balance of rotation in a far more stable manner.

According to another preferred embodiment of the present invention, the holding member has a plurality of projections on a surface. According to this configuration, the surface area of the holding member can be made as large as possible to increase the force to suck the balancer by surface tension, whereby the holding member may hold the balancer far more reliably. If impact or the like is applied to the automatic balancing apparatus, for example, the balancer moves toward the outer circumferential side, so that if a disc is made to rotate when the balancer is accumulated on the outer circumferential side, for example, the automatic balancing apparatus cannot stabilize the balance of rotation during an early period of rotation. However, according to the preferred embodiment of the present invention, since the plurality of projections are provided on the holding member, the balancer may be prevented, as much as possible, from easily flowing toward the outer circumferential side of the holding member when impact is applied to the automatic balancing apparatus, whereby the automatic balancing apparatus may avoid the above-mentioned problems.

According to another preferred embodiment of the present invention, the projections are formed to become gradually larger in surface area from the outer circumferential side toward the inner circumferential side of the holding member. According to this configuration, the difference in surface area between the projections may be used to increase the force of the holding member to suck the balancer by surface tension from the outer circumferential side toward the inner circumferential side of the holding member, whereby the holding member may hold the balancer far more reliably. The term “gradually” means “continuously”, “stepwise”, or a combination of “continuously” and “stepwise”. In the following description, the meaning of the term “gradually” is to be similarly construed.

According to another preferred embodiment of the present invention, the holding member has a first surface, a first plate having a plurality of first projections projecting from the first surface, a second surface opposed to the first surface, and a second plate having a plurality of second projections provided to project from the second surface toward the first surface and provided to overlap with the first projections in a projecting direction of the second projections. According to this configuration, the first projections and the second projections are provided so that each of the first projections overlaps with a respective one of the second projections. Accordingly, the surface tension of the balancer is increased, and the projections may prevent far more reliably the balancer from easily flowing toward the outer circumferential side of the holding member, when impact or acceleration is applied to the automatic balancing apparatus, for example.

According to another preferred embodiment of the present invention, the housing member has a surface provided in the inside of the housing member and approximately perpendicular to the rotation axis direction, a lateral surface provided on the outer circumferential side of the inside and approximately parallel with the rotation axis direction, and a curved surface provided to extend from the surface to the curved surface. The presence of the curved surface does not easily allow the balancer to remain between the surface and the lateral surface, whereby the balancer may return to the holding member when the rotation speed of the holding member is reduced. The term “surface” means the top surface or the bottom surface of the inside of the holding member. The term “curved surface” means a curved surface which is intentionally formed so as not to easily allow the balancer to remain between the surface and the lateral surface. If the inside diameter of the housing member is on the order of approximately 2 to 5 cm, for example, the curved surface is preferably not less than 0.5 mm and not larger than 2 mm.

According to another preferred embodiment of the present invention, the holding member has a top surface provided in the inside of the holding member and approximately perpendicular to the rotation axis direction, a bottom surface provided in the inside and opposed to the top surface, and a curved surface provided on the outer circumferential side and provided to extend from the top surface toward the bottom surface. According to this configuration, the balancer does not easily allowed to remain on the outer circumferential side, so that the balancer may rapidly return to the holding member when the rotation speed of the holding member is reduced.

According to another preferred embodiment of the present invention, the restrictive member has a restrictive surface approximately parallel with the rotation axis direction of the holding member, and the holding member has a lateral surface provided on the outer circumferential side and a curved surface provided to extend from the restrictive surface to the lateral surface. The presence of this curved surface does not easily allow the balancer to remain between the restrictive surface of the restrictive member and the lateral surface of the holding member. Accordingly, the balancer may rapidly return to the holding member when the rotation speed of the holding member is reduced.

According to another preferred embodiment of the present invention, the holding member has a surface provided in the inside of the holding member and approximately perpendicular to a rotation axis direction, a lateral surface provided on the outer circumferential side of the inside and approximately parallel with the rotation axis direction, and an inclined surface provided to extend from the surface to the lateral surface so that the internal volume of the housing member gradually decreases from the inner circumferential side toward the outer circumferential side. The presence of this inclined surface does not easily allow the balancer to remain between the surface and the lateral surface. In addition, in the case where the surface is located at the bottom of the holding member, i.e., the automatic balancing apparatus is used with the rotation axis direction of the holding member positioned approximately perpendicularly to the ground (hereinafter, referred to the “horizontal attitude”), for example, when the rotation speed of the housing member is reduced, the balancer may rapidly return to the holding member by its own weight owing to the inclined surface.

According to another preferred embodiment of the present invention, the holding member has a plurality of grooves formed to extend from the outer circumferential side toward the inner circumferential side. Accordingly, the balancer may easily return to the inner circumferential side.

According to another preferred embodiment of the present invention, at least one of the grooves is provided to become gradually thinner from the outer circumferential side toward the inner circumferential side. Accordingly, surface tension which acts on the balancer may be made gradually larger from the outer circumferential side toward the inner circumferential side.

According to another preferred embodiment of the present invention, at least one of the grooves extends in a direction different from the rotation radius direction of the holding member. When the rotation speed of the housing member is reduced, for example, the balancer tries to move by inertia in the rotation direction, and in this modification, since at least one of the grooves extends in a direction as close to the rotation direction as possible, the balancer may be reliably returned to the holding member.

According to another preferred embodiment of the present invention, the grooves are provided on the outer circumferential side with respect to the holding member. Accordingly, the balancer accumulated on the outer circumferential side may easily return to the holding member.

According to another preferred embodiment of the present invention, the holding member and the restrictive member are in abutment with each other. Even in the case where the automatic balancing apparatus is used with the rotation axis direction of the holding member positioned approximately in parallel with the ground (hereinafter, referred to the “vertical attitude”), for example, when the rotation speed of the housing member is reduced, the balancer may reliably return to the holding member. The term “abutment” means, for example, the state in which the holding member and the restrictive member are in abutment in the state of overlapping each other in the rotation radius direction of the holding member.

A rotative apparatus according to a preferred embodiment of the present invention includes a balancer made of a fluid, a holding member constructed to hold the balancer by generating surface tension in the balancer, a housing member in which the balancer and the holding member are housed, and a drive section capable of rotating the housing member integrally with the holding member so that the balancer held by the holding member on an inner circumferential side of the housing member moves toward an outer circumferential side of the housing member by centrifugal force due to rotation.

According to the preferred embodiment of the present invention, the automatic balancing apparatus may hold the balancer on the inner circumferential side of the holding member by using surface tension irrespective of the attitude of the rotative apparatus. Accordingly, the automatic balancing apparatus may start rotating with the balancer held by the holding member irrespective of the attitude of the automatic balancing apparatus, whereby the balance of rotation may be improved in a stable manner.

A disc drive according to a preferred embodiment of the present invention includes a drive section constructed to rotationally drive a disc on which data may be recorded, and an automatic balancing apparatus having a balancer made of a fluid, a holding member constructed to hold the balancer by generating surface tension in the balancer, and a holding member which is provided so as to be rotated by the drive section and in which a balancer and the holding member are housed so that the balancer held by the holding member on an inner circumferential side of the housing member moves toward an outer circumferential side of the housing member by centrifugal force due to rotation.

In the present invention, the term “disc” may include optical discs such as CDs (Compact Discs), DVDs (Digital Versatile Disks) and Blu-ray (a trademark) discs, magneto optical discs such as MOs (Magneto Optical Disks) and MDs (Mini-Disk, a trademark), and magnetic discs such as hard disks, for example. The term “disc drive” means a device which can perform at least either one of recording of data on a disc and reproduction of data recorded on a disc.

An automatic balancing apparatus according to another preferred embodiment of the present invention includes a balancer made of a magnetic fluid, a magnet for holding the balancer, a housing member which is rotatably provided and in which the balancer and the magnet are housed so that the balancer held by the magnet on an inner circumferential side of the housing member moves toward an outer circumferential side of the housing member by centrifugal force due to rotation, and a restrictive member provided on the outer circumferential side of the housing member and operative to restrict movement of the balancer in a circumferential direction when the housing member rotates.

According to the preferred embodiments of the present invention, the balancer is held on the inner circumferential side of the holding member by means of the magnetism of the balancer irrespective of the attitude of the automatic balancing apparatus, whereby a disc can be rotated with the balancer held by the holding member irrespective of the attitude of the automatic balancing apparatus. In addition, the restrictive member is provided, whereby even if the amplitude of vibration of the disc is small, for example, the balanced state of rotation of the disc can be ensured by the balancer locally accumulated by the restrictive member as in the present invention.

As described above, according to the preferred embodiment of the present invention, the automatic balancing apparatus may starts rotating with the balancer held on the inner circumferential side of the holding member by means of the magnetism of the balancer irrespective of the attitude of the automatic balancing apparatus, whereby the balance of rotation may be improved.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a horizontal cross-sectional view showing an automatic balancing apparatus according to a first preferred embodiment of the present invention (a cross-sectional view of the automatic balancing apparatus, taken along line B-B of FIG. 2);

FIG. 2 is a vertical cross-sectional view of the automatic balancing apparatus shown in FIG. 1 (taken along line A-A of FIG. 1);

FIG. 3 is a vertical cross-sectional view of a disc rotation apparatus according to the first preferred embodiment of the present invention;

FIG. 4 is a horizontal cross-sectional view showing an automatic balancing apparatus according to a second preferred embodiment of the present invention (a cross-sectional view of the automatic balancing apparatus, taken along line E-E of FIG. 5);

FIG. 5 is a vertical cross-sectional view showing the automatic balancing apparatus shown in FIG. 4 (taken along line C-C of FIG. 4);

FIG. 6 is a horizontal cross-sectional view showing an automatic balancing apparatus according to a third preferred embodiment of the present invention (a cross-sectional view of the automatic balancing apparatus, taken along line J-J of FIG. 7);

FIG. 7 is a vertical cross-sectional view of the automatic balancing apparatus shown in FIG. 6 (taken along line F-F of FIG. 6);

FIG. 8 is a cross-sectional view of the automatic balancing apparatus shown in FIG. 6, taken along line H-H of FIG. 6;

FIG. 9 is a horizontal cross-sectional view showing an automatic balancing apparatus according to a fourth preferred embodiment of the present invention (a cross-sectional view of the automatic balancing apparatus, taken along line L-L of FIG. 10);

FIG. 10 is a vertical cross-sectional view of the automatic balancing apparatus shown in FIG. 9 (taken along line K-K of FIG. 9);

FIG. 11 is a vertical cross-sectional view of an automatic balancing apparatus according to a fifth preferred embodiment of the present invention;

FIG. 12 is an enlarged cross-sectional view of plates of a holding member of an automatic balancing apparatus according to a sixth preferred embodiment of the present invention;

FIG. 13 is an enlarged cross-sectional view of plates of a holding member of an automatic balancing apparatus according to a seventh preferred embodiment of the present invention;

FIG. 14 is an enlarged cross-sectional view of plates of a holding member of an automatic balancing apparatus according to an eighth preferred embodiment of the present invention;

FIG. 15 is a cross-sectional view showing a modification of the automatic balancing apparatus shown in FIGS. 4 and 5;

FIG. 16 is a cross-sectional view showing a modification of the automatic balancing apparatus shown in FIGS. 4 and 5;

FIG. 17 is a cross-sectional view showing an automatic balancing apparatus according to a ninth preferred embodiment of the present invention;

FIG. 18 is a cross-sectional view showing a modification of the automatic balancing apparatus shown in FIG. 17;

FIG. 19 is a cross-sectional view showing an automatic balancing apparatus according to a tenth preferred embodiment of the present invention;

FIG. 20 is a cross-sectional view showing a modification of the automatic balancing apparatus shown in FIG. 19;

FIG. 21 is a cross-sectional view showing a modification of the automatic balancing apparatus shown in FIGS. 19 and 20;

FIG. 22 is a cross-sectional view showing an automatic balancing apparatus according to an eleventh preferred embodiment of the present invention;

FIG. 23 is a cross-sectional view taken along line M-M of FIG. 22;

FIG. 24 is across-sectional view showing a modification of the automatic balancing apparatus shown in FIG. 22;

FIG. 25 is a cross-sectional view showing a modification of the automatic balancing apparatus shown in FIG. 22; and

FIG. 26 is a cross-sectional view showing a modification of the automatic balancing apparatus shown in FIG. 22.

### DESCRIPTION OF THE PREFERRED EMBODIMENTS

Preferred embodiments of the present invention will be described below with reference to the accompanying drawings.

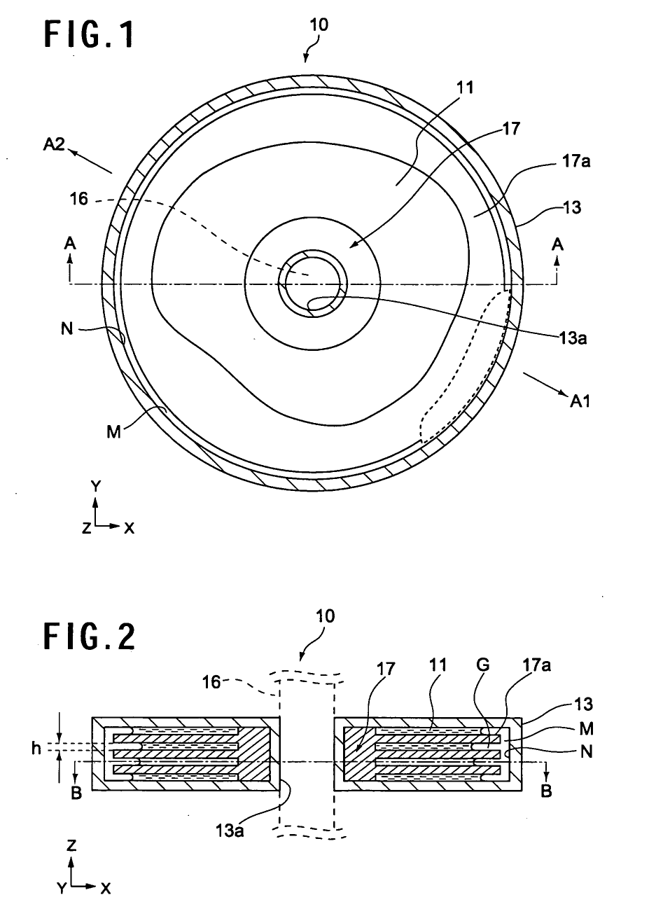

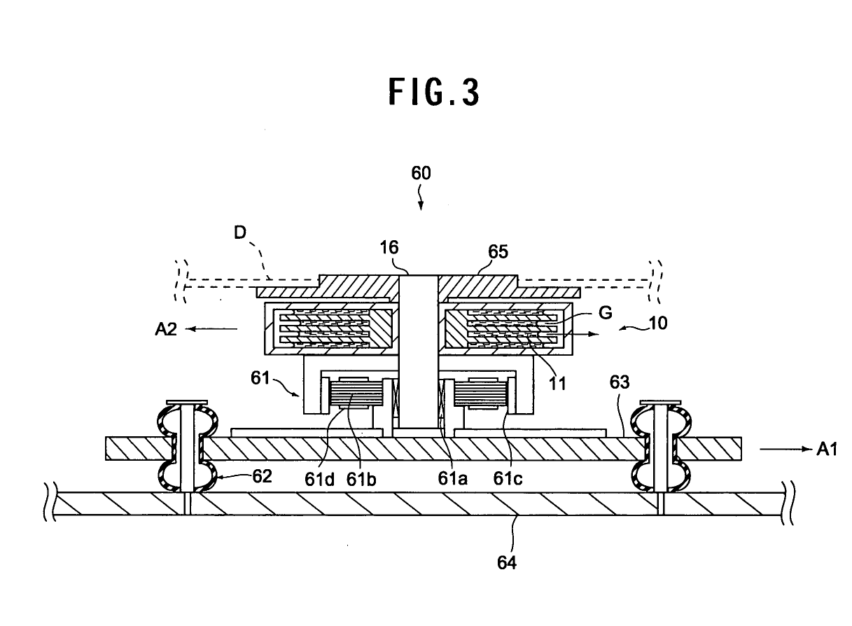

FIGS. 1 and 2 represent, respectively, horizontal and vertical cross-sectional views showing an automatic balancing apparatus according to a first preferred embodiment of the present invention. FIG. 3 is a vertical cross-sectional view showing a disc rotation apparatus according to the first preferred embodiment of the present invention.

As shown in FIGS. 1 and 2, an automatic balancing apparatus 10 according to the first preferred embodiment includes a fluid balancer 11, a holding member 17 which holds the balancer 11 by surface tension, and a housing member 13 in which the balancer 11 and the holding member 17 are housed.

The housing member 13 has a disk-like shape having a hollow section, and the balancer 11 and the holding member 17 are housed in this hollow section. The balancer 11 uses water or oil, for example. A through-hole 13a through which a rotation shaft 16 of a motor 61 shown in FIG. 3 is provided in the housing member 13 is provided at the center of the housing member 13. The constituent material of the housing member 13 uses metal or synthetic resin, for example.

The holding member 17 has a plurality of plates 17a provided to be stacked at a predetermined interval h in the Z direction which corresponds to the axial direction of rotation of the holding member 17. The interval h is preferably set to be no larger than several hundred μm, for example, whereby surface tension occurring in the balancer 11 can be made still larger. Each of the plates 17a has a disk-like shape with approximately the same size. A gap G which serves as a flow path for the balancer 11 is formed between each of the plates 17a, and when the motor 61 is in a stationary state, for example, the balancer 11 is held in the gaps G. The holding member 17 may be formed by integral molding with a resin material, or may also be fabricated by inserting a cylindrical member which constitutes a boss section into a plurality of disk-shaped members each having a through-hole. A gap M is formed between an outer circumferential surface of the holding member 17 and an inner circumferential surface N of an outer side wall of the housing member 13. The constituent material of the holding member 17 is metal or synthetic resin, for example.

A disc rotation apparatus 60 has the motor 61, and a turntable 65 is provided at the top end section of the rotation shaft 16 of the motor 61. The motor 61 has a stator 61b provided with a coil 61d in which, for example, a drive current flows, a rotor 61c rotatably supported by a bearing 61a, and the rotation shaft 16. The automatic balancing apparatus 10 is provided on the rotation shaft 16. The automatic balancing apparatus 10 is constructed so as to integrally rotate with the rotation shaft 16. The motor 61 is supported by a subchassis 63, and the subchassis 63 is supported on a main chassis 64 by means of elastic sections 62 each including a polymer material such as rubber, a metal-made member and the like, whereby a vibration system is constructed. For example, the resonance frequency of the vibration system based on the deformation of the elastic sections 62 is set to be lower than the rotation frequency of a disc D.

The operation of the automatic balancing apparatus 10 will be described below with reference to the drawings.

When the disc D is set on the turntable 65 and the motor 61 starts rotation, the vibration system starts to vibrate. While the motor 61 rotates at low speed, the centrifugal force is lower than the force of the holding member 17 to hold the balancer 11 by surface tension, frictional force and the like, and the balancer 11 is held on an inner circumferential side of the holding member 17.

When the rotation speed of the motor 61 increases and the rotation frequency of the motor 61 exceeds the resonance frequency of the vibration system, a direction A1 in which the vibration system vibrates becomes approximately opposite to a direction A2 in which the disc D deviates from the rotation center of the motor 61. At this time, the balancer 11 moves in the direction A1 in which the vibration system vibrates, with acceleration due to the vibration of the vibration system, and the direction (A1) in which the balancer 11 moves and the direction A2 in which the disc D deviates become approximately opposite to each other, whereby the balance of rotation of the disc D is ensured.

When the rotation speed of the motor 61 further increases, the force of the holding member 17 to hold the balancer 11 exceeds the centrifugal force, and as shown by a dashed line in FIG. 1, the balancer 11 is moved toward an outer circumferential side of the holding member 17 by the centrifugal force. The movement of the balancer 11 is restricted by the housing member 13. As a matter of course, the balance of rotation is ensured at this time as well.

As the rotation speed of the motor 61 decreases, the centrifugal force decreases, and when the centrifugal force decreases below the force of the holding member 17 to hold the balancer 11, the balancer 11 is again held on the inner circumferential side of the holding member 17.

It is preferable to set the rotation speed of the motor 61 (for example, the rotation speed at which signals recorded on the disc D are reproduced) and the material and the like of the elastic sections 62 so that the direction A1 and the direction A2 can be opposed to each other at approximately 180 degrees.

According to the first preferred embodiment, since the automatic balancing apparatus 10 includes the holding member 17, the balancer 11 can be held on the inner circumferential side of the holding member 17 by means of surface tension irrespective of the attitude of the automatic balancing apparatus 10. Accordingly, the automatic balancing apparatus 10 can start rotating with the balancer 11 held by the holding member 17 irrespective of the attitude of the automatic balancing apparatus 10, whereby the balance of rotation of the automatic balancing apparatus 10 can be improved.

In the first preferred embodiment, the holding member 17 has the plurality of plates 17a provided to be stacked at the predetermined interval h in the Z direction. According to this configuration, the balancer 11 can be efficiently held in the gaps G. In addition, if the number of the plates 17a is increased or the interval h is reduced, the capability of the holding member 17 to hold the balancer 11 can be improved, whereby the balancer 11 can be far more reliably held by the holding member 17. The interval h is preferably set to be not larger than several hundred μm, for example.

In the first preferred embodiment, a fluid is used as the balancer 11. Accordingly, since the impact of the balancer 11 can be reduced during the operation of the disc rotation apparatus 60, the disc rotation apparatus 60 can be made to operate with reduced noise and little vibration.

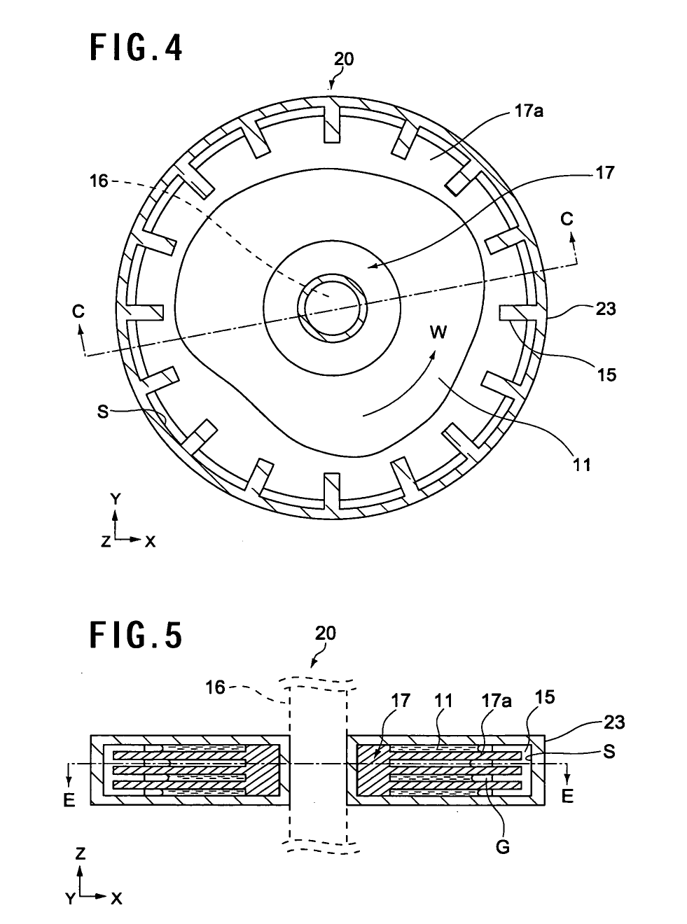

FIGS. 4 and 5 represent, respectively, horizontal and vertical cross-sectional views showing an automatic balancing apparatus according to a second preferred embodiment of the present invention.

An automatic balancing apparatus 20 according to the second preferred embodiment includes, instead of the housing member 13, a housing member 23 having a plurality of restrictive members 15 which restrict the flow of the balancer 11 in a circumferential direction W. The restrictive members 15 are provided to project from an inner circumferential surface S of the outer side wall of the housing member 23 toward the center of the housing member 23. Each of the restrictive members 15 is spaced apart from its adjacent one at an approximately regular interval in the circumferential direction W. Each of the restrictive members 15 is provided in the hollow section of the housing member 23 so as to extend in the Z direction across the entire thickness of the hollow section. In addition, the number, the shape, the material and the like of the restrictive members 15 are not limitative. For example, the restrictive members 15 may be constructed by preparing planar members which serve as the restrictive members 15 separately from the housing member 13 of the first preferred embodiment, and welding the planar members to an inner circumferential surface N of the housing member 13 (refer to FIG. 2). Otherwise, the restrictive members 15 may also be formed by integral molding with a resin material.

In the second preferred embodiment, the movement of the balancer 11 toward the outer circumferential side due to the rotation of the automatic balancing apparatus 20 is temporarily restricted by the inner circumferential side S of the housing member 23, and the flow of the balancer 11 in the circumferential direction W along the inner circumferential side S is restricted by the restrictive members 15. Accordingly, even if the amplitude of vibration during the rotation of the disc D is small, for example, the balanced state of rotation of the disc D can be ensured by the balancer 11 locally accumulated by the restrictive members 15. When the automatic balancing apparatus 20 is used in a vertical state, for example, the balancer 11 tends to easily vertically deviate downwardly by centrifugal force or gravitational force. However, since the balancer 11 is held on the inner circumferential side by the holding member 17 at the starting time of rotation of the motor 61, the provision of the restrictive members 15 does not cause any problem. In other words, in the case where the restrictive members 15 are provided, if the balancer 11 remains accumulated in a bottom section of the housing member 23 by gravitational force, the balancing performance of the automatic balancing apparatus 20 will decrease at a subsequent starting time of rotation of the motor 61.

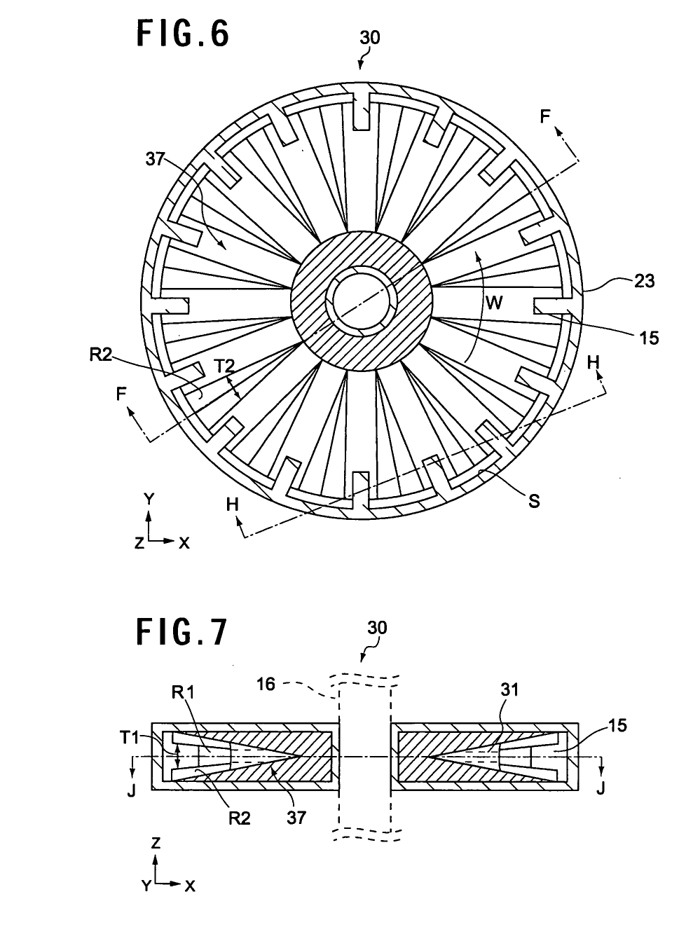

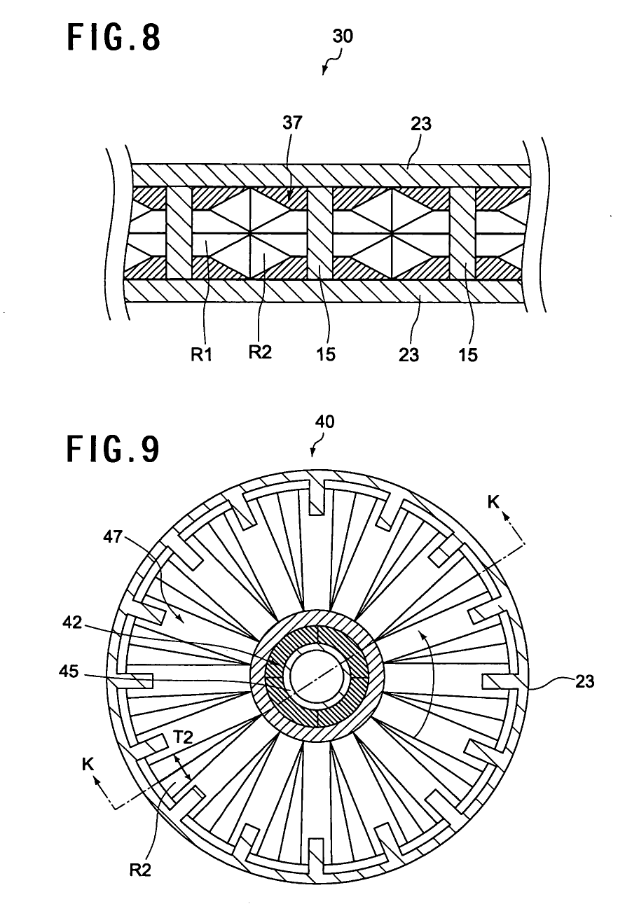

FIGS. 6 and 7 represent, respectively, horizontal and vertical cross-sectional views showing an automatic balancing apparatus according to a third preferred embodiment of the present invention. FIG. 8 is a cross-sectional view of the automatic balancing apparatus shown in FIG. 6, taken along line H-H of FIG. 6.

In the third preferred embodiment, an automatic balancing apparatus 30 has, instead of the holding member 17 of the second preferred embodiment, a holding member 37 which forms a flow path R1 through which to circulate a balancer 31. The width of the flow path R1 in the Z direction is set to a width T1 which becomes narrower from the outer circumferential side toward the inner circumferential side of the holding member 37. The holding member 37 forms flow paths R2 each having a width T2 in the circumferential direction W, which width T2 is set to become narrower from the outer circumferential side toward the inner circumferential side of the holding member 37. Each of the flow paths R2 has an approximately V-like shape as shown in FIG. 8. The flow path R1 is provided to extend around the housing member 23 in the circumferential direction W. The flow paths R2 are arranged so that, for example, one flow path R2 is provided between each of the restrictive members 15.

In the third preferred embodiment, since the flow paths R1 and R2 are formed each of which becomes narrower from the outer circumferential side toward the inner circumferential side of the holding member 37, the force of the holding member 37 to hold the balancer 31 by surface tension and the like on the inner circumferential side of the holding member 37 can be increased, whereby the balancer 31 can be more reliably held to improve the balance of rotation of the automatic balancing apparatus 30.

The inclination angles of the inclined or slanted surfaces of the holding member 37 which form the flow paths R1 and R2, as well as the number of the flow paths R2 are not limitative. For example, one flow path R2 may be provided between each alternate one of the restrictive members 15, or a plurality of flow paths R2 may be provided between each of the restrictive members 15. Otherwise, only the flow path R1 may be provided, and the flow paths R2 may be omitted. Accordingly, a low-cost configuration can be realized compared to the case where both the flow paths R1 and R2 are provided in the holding member 37.

FIGS. 9 and 10 represent, respectively, horizontal and vertical cross-sectional views showing an automatic balancing apparatus according to a fourth preferred embodiment of the present invention.

An automatic balancing apparatus 40 according to the fourth preferred embodiment has a permanent magnet 42 provided on the inner circumferential side of the housing member 23. The permanent magnet 42 is made of a plurality of small permanent magnets each having a curved shape and provided to surround a side circumferential wall 45 of the housing member 23 on the inner circumferential side thereof. Each of the small magnets is magnetized to have, for example, an N pole on one side and an S pole on the other side in the Z direction. A magnetic fluid, for example, a ferro-fluid (a trademark of IBM Corporation) or a magneto-rheological fluid (MR fluid) is used instead of the balancer 31.

According to the fourth preferred embodiment, a balancer 41 can be held on a holding member 47 not only by the surface tension of the balancer 41 but also by magnetic force. Accordingly, the capability of the holding member 47 to hold the balancer 41 can be improved to improve in a far more stable manner the balance of rotation of the automatic balancing apparatus 40 which is located in vertical attitude and the like.

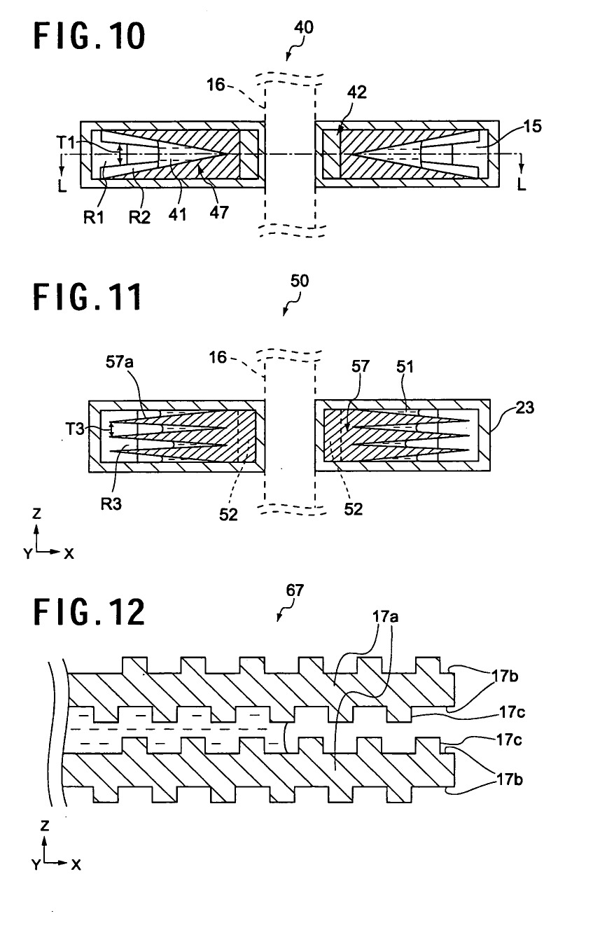

FIG. 11 is a vertical cross-sectional view showing an automatic balancing apparatus according to a fifth preferred embodiment of the present invention.

In the fifth preferred embodiment, a holding member 57 of an automatic balancing apparatus 50 has a plurality of tapered plates 57a provided to be stacked in the Z direction, and a flow path R3 having a width T3 in the Z direction, which becomes narrower from the outer circumferential side toward the inner circumferential side of the housing member 23, is formed between each of the plates 57a. In other words, tapered members each having a width (thickness) in the Z direction which becomes narrower from the inner circumferential side toward the outer circumferential side, for example, are used as the plates 57a. Accordingly, surface tension and the like which become larger from the outer circumferential side toward the inner circumferential side of the housing member 23 can be used to increase the force of the holding member 57 to hold a balancer 51, whereby the balancer 51 can be efficiently held in the flow paths R3. In addition, the capability of the holding member 57 to hold the balancer 51 may also be increased by increasing the number of the plates 57a or by decreasing the widths T3 of the respective flow paths R3 in the Z direction.

FIG. 12 is an enlarged cross-sectional view of plates of a holding member of an automatic balancing apparatus according to a sixth preferred embodiment of the present invention.

In the sixth preferred embodiment, a holding member 67 having projections 17c formed to project in the Z direction from each surface 17b of each of the plates 17a of the holding member 67 is used instead of the holding member 17 of the first preferred embodiment. Accordingly, the capability of the holding member 67 to hold a balancer can be improved, whereby the stability of rotation of the automatic balancing apparatus during an earlier period can be improved. In addition, the projections 17c can prevent, as much as possible, the balancer from easily flowing toward the outer circumferential side of the holding member 67 when impact or acceleration is applied to the automatic balancing apparatus.

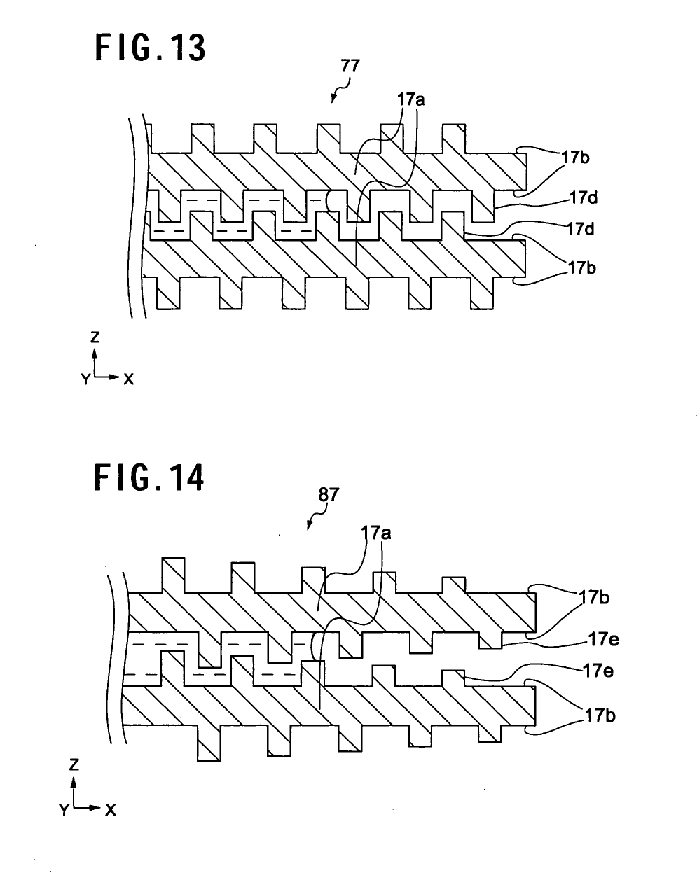

FIG. 13 is an enlarged cross-sectional view of plates of a holding member of an automatic balancing apparatus according to a seventh preferred embodiment of the present invention.

In the seventh preferred embodiment, unlike the sixth preferred embodiment, projections 17d are provided to project in the Z direction from each of the surfaces 17b of each of the plates 17a so that the projections 17d on each of the surfaces 17b overlap with the projections 17d on the opposed one. Accordingly, the surface tension of a balancer is increased, and the projections 17d can prevent far more reliably the balancer from easily flowing toward the outer circumferential side of a holding member 77, for example, when impact or acceleration is applied to the automatic balancing apparatus.

FIG. 14 is an enlarged cross-sectional view of plates of a holding member of an automatic balancing apparatus according to an eighth preferred embodiment of the present invention.

In the eighth preferred embodiment, unlike the seventh preferred embodiment, a plurality of projections 17e are provided so that their surface areas become gradually larger from the outer circumferential side toward the inner circumferential side of the housing member 23. In other words, the lengths of the respective projections 17e in the Z direction are set to become gradually smaller from the inner circumferential side toward the outer circumferential side of the housing member 23. Accordingly, the difference in surface area between the projections 17e can be used to increase the force of a holding member 87 to hold the balancer 11 by surface tension from the outer circumferential side toward the inner circumferential side of the holding member 87, whereby the holding member 87 can hold the balancer 11 far more reliably.

While preferred embodiments of the present invention have been described with reference to the attached drawings, it is to be understood that the present invention is not limited to the embodiments described above. It will be obvious to those skilled in the art that various changes, modifications, combinations, sub combinations and alterations may be made depending on design requirements and other factors insofar as they are within the scope of the appended claims or equivalents thereof.

While in each of the second and third preferred embodiments, reference has been made to the example in which a gap is formed between the outer circumferential surface of the holding member 17 (37) and the inner circumferential surface S of the outer side wall of the housing member 23, the outer circumferential surface of the holding member 17 (37) may be positioned in contact with the inner circumferential surface S of the outside side wall of the housing member 23. This configuration makes it possible to suck a balancer 31 from the outermost circumferential side of the housing member 23.

In the fifth preferred embodiment, as shown by dashed lines in FIG. 11, a permanent magnet 52 may also be provided on the inner circumferential side of the housing member 23 similarly to the case of the fourth preferred embodiment. In this configuration, the balancer 51 can be held on the holding member 57 by not only surface tension but also magnetic force.

While in each of the sixth to eighth preferred embodiments, reference has been made to the example in which the plurality of projections 17c (17d and 17e) are provided on each of the opposite surfaces 17b of each of the plates 17a so as to increase the surface area of each of the plates 17a. However, the holding member may also be made porous to increase the capability of the holding member to hold the balancer. In addition, the projections 17c, 17d or 17e may also be provided on the inclined surfaces which form the flow path R1 shown in FIG. 7 or on the inclined surfaces of each of the plates 57a shown in FIG. 11.

Any of the automatic balancing apparatuses 10 to 50 of the first to fifth preferred embodiments as well as the disc rotation apparatus 60 can be incorporated into optical disc drives, magnetic disc drives, video cameras using optical discs as recording media, and the like. If any of the automatic balancing apparatuses 10 to 50 as well as the disc rotation apparatus 60 is incorporated into a video camera of hand-carried type, the balance of rotation of a disc in the video camera can be improved to improve the stability of recording and reproduction of data (playback).

The permanent magnet 42 as shown in FIGS. 9 and 10 may also be provided on an inner circumferential side of the housing member 13 provided in the automatic balancing apparatus 10 according to the first preferred embodiment. The permanent magnet 42 may also have a ring-like shape instead of being divided into four parts as shown in FIG. 9. The magnetization direction of the permanent magnet 42 can be set to any of the rotation axis direction, the rotation circumference direction and the rotation radius direction of the housing member 13 or 23.

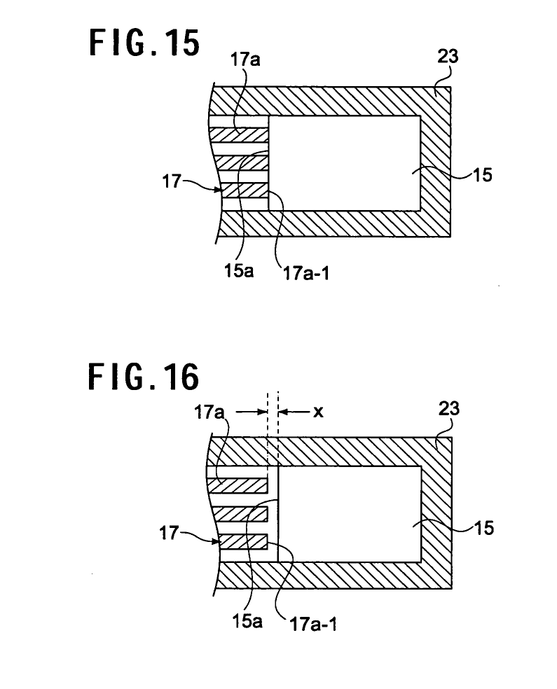

In FIGS. 4 and 5, there is shown a configuration in which the outer circumferential sections of the respective plates 17a of the holding member 17 provided in the housing member 23 and the inner end sections of the respective restrictive members 15 overlap with each other in the axial direction of rotation of the housing member 23. However, instead of this overlap configuration, it is also possible to adopt a configuration in which, as shown in FIG. 15, outer circumferential sections 17a-1 of the respective plates 17a of the holding member 17 and inner ends 15a of the respective restrictive members 15 are provided in opposition to and in abutment with each other. Otherwise, as shown in FIG. 16, a gap x may be formed between the outer circumferential sections 17a-1 of the respective plates 17a of the holding member 17 and the inner ends 15a of the respective restrictive members 15. This gap x is selected to become a gap which does not hinder the balancer restricted by the outer circumferential side of the housing member 23, i.e., the restrictive members 15, from acting to substantially return to the holding member 17 by means of the viscosity, the surface tension and the like of the balancer when the rotation speed of the housing member 23 is reduced.

The description of the configurations as shown in FIGS. 15 and 16 may be similarly applied to the holding member 37, 47, 57 and 67 shown in FIGS. 7 and 9 to 11.

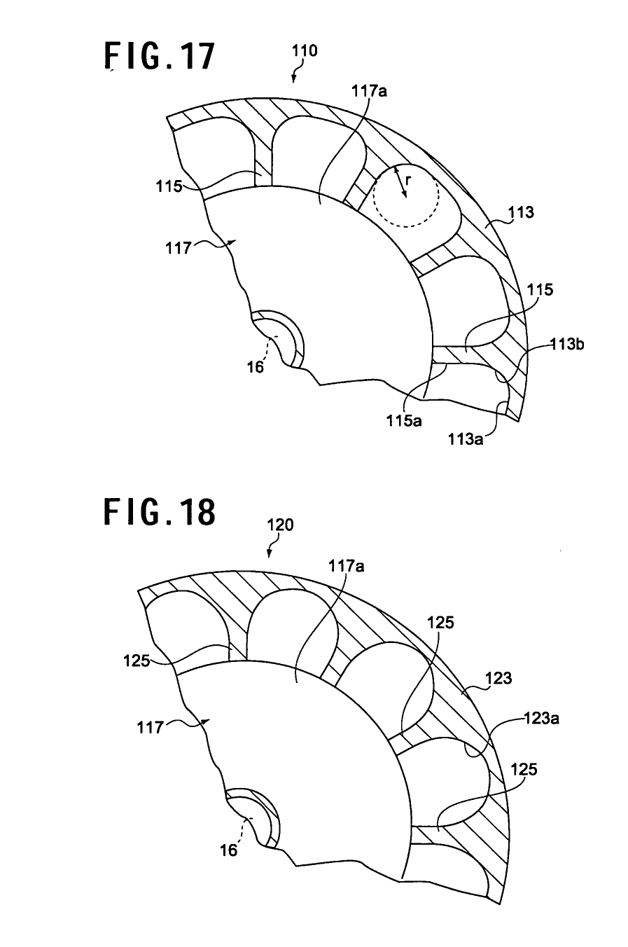

FIG. 17 is a cross-sectional view showing an automatic balancing apparatus according to a ninth preferred embodiment of the present invention. The drawing of each preferred embodiment which will be mentioned below shows only part of an automatic balancing apparatus.

In an automatic balancing apparatus 110, restrictive members 115 project from an outer circumferential lateral surface 113a (a plane approximately parallel with the axial direction of the rotation shaft 16) in the inside of a housing member 113, and are brought into abutment with the holding member 117. The shapes of plates 117a of this holding member 117 are similar to those of the plates 17a shown in FIGS. 1 and 2, for example, but this configuration is not limitative, and the plates 117a may also have the shape shown in any of FIGS. 6 to 14 by way example. A similar description applies to the shape of the holding member 117 shown in FIG. 18 which will be mentioned later.

As shown in FIG. 17, a section which extends from a restrictive surface 115a of each of the restrictive members 115 (a plane approximately parallel with the axial direction of the rotation shaft 16) to the lateral surface 113a of the housing member 113 is formed in the shape of a curved surface 113b. If the inside diameter of the housing member 113 is on the order of approximately 2 to 5 cm, for example, the radius of curvature r of the curved surface 113b is not less than 0.5 mm and not larger than 2 mm. The presence of the curved surfaces 113b does not easily allow the balancer to remain between any of the restrictive surfaces 115a and the lateral surface 113a. Accordingly, even if the automatic balancing apparatus 110 is located in vertical attitude, the balancer can rapidly return to the holding member 117 when the rotation speed of the housing member 113 is reduced. The term “vertical attitude” means the attitude of the automatic balancing apparatus 110 which causes the rotation shaft 16 to be approximately parallel with the ground.

FIG. 18 is across-sectional view showing a modification of the automatic balancing apparatus 110 shown in FIG. 17. In an automatic balancing apparatus 120, a housing member 123 has restrictive members 125 each uniformly formed of a curved surface 123a. In this configuration, since the whole of the section between each of the restrictive members 125 has the shape of a curved surface, the balancer can be more easily prevented from remaining between the restrictive members 125 than can be done by the configuration shown in FIG. 17.

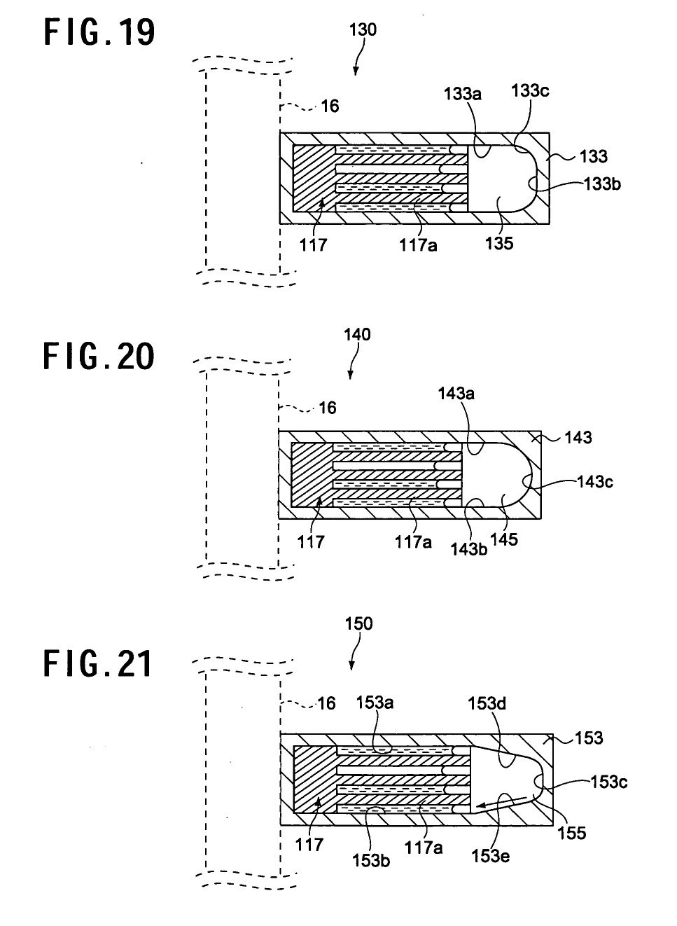

FIG. 19 is a cross-sectional view showing an automatic balancing apparatus according to a tenth preferred embodiment of the present invention. Each of FIGS. 19, 20 and 21 shows only the half section of the automatic balancing apparatus on one side of the rotation shaft 16. An automatic balancing apparatus 130 has curved surfaces 133c each of which extends from a respective one of top and bottom surfaces 133a of the inside of a housing member 133 (surfaces approximately perpendicular to the axial direction of the rotation shaft 16) to an outer circumferential lateral surface 133b (a surface approximately parallel with the axial direction of the rotation shaft 16). According to this configuration, the balancer that is near the restrictive members 135 can rapidly return to the sections between the plates 117a of the holding member 117 when the rotation speed of the housing member 133 is reduced.

FIG. 20 is a cross-sectional view showing a modification of the automatic balancing apparatus 130 shown in FIG. 19. An automatic balancing apparatus 140 has a curved surface 143c which extends from a top surface 143a to a bottom surface 143b of the inside of a housing member 143. According to this configuration as well, the balancer located near the restrictive members 145 can rapidly return to the sections between the plates 117a of the holding member 117 when the rotation speed of the housing member 143 is reduced.

FIG. 21 is a cross-sectional view showing a modification of each of the automatic balancing apparatuses 130 and 140 shown in FIGS. 19 and 20. An automatic balancing apparatus 150 has inclined surfaces 153d and 153e respectively formed to extend from a top surface 153a and a bottom surface 153b of the inside of a housing member 153 toward an outer circumferential lateral surface 153c so as to gradually decrease the internal volume of the housing member 153 from the inner circumferential side toward the outer circumferential side. Accordingly, even if the automatic balancing apparatus 150 is located in horizontal attitude, for example, the balancer can rapidly return to the sections between the plates 117a of the holding member 117 by its own weight when the rotation speed of the housing member 153 is reduced. The term “horizontal attitude” means the attitude of the automatic balancing apparatus 150 which causes the rotation shaft 16 to be approximately perpendicular to the ground.

In the configuration shown in FIG. 21, if the automatic balancing apparatus 150 is located in an upside-down horizontal attitude, the balancer returns to the sections between the plates 117a of the holding member 117 along the inclined surface 153d on the side of the top surface 153a by its own weight. Although in the configuration shown in FIG. 21 the inclined surfaces 153d and 153e are respectively formed on the top and bottom sides, either one of the inclined surfaces 153d or 153e may also be formed on one of the top and bottom sides. In addition, any one of the configurations shown in FIGS. 19 to 21 can be combined with either one of the configurations shown in FIGS. 17 and 18.

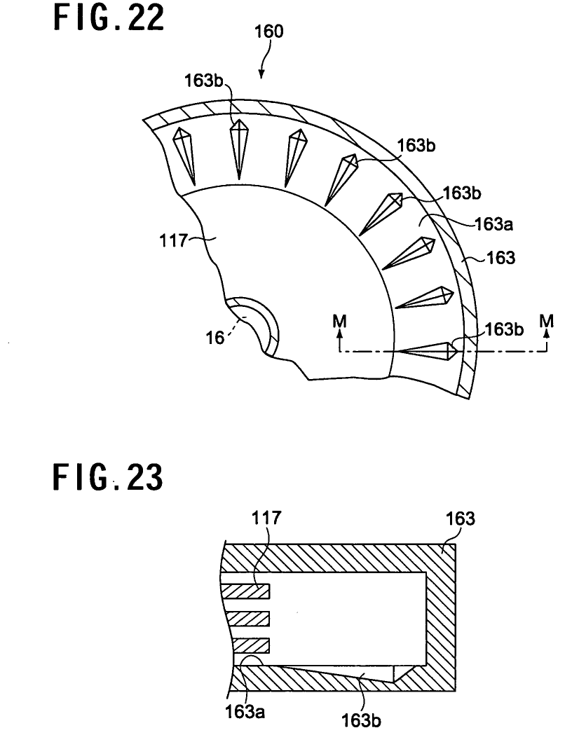

FIG. 22 is a cross-sectional view showing an automatic balancing apparatus according to an eleventh preferred embodiment of the present invention. FIG. 23 is a cross-sectional section taken along line M-M of FIG. 22.

In an automatic balancing apparatus 160, a plurality of grooves 163b are formed in a bottom surface 163a of a housing member 163 on the outer circumferential side thereof. Each of the grooves 163b is provided on the outer circumferential side of the holding member 117 and is formed to become gradually thinner from the outer circumferential side toward the inner circumferential side of the housing member 163. Specifically, each of the grooves 163b is formed to become gradually narrower from the outer circumferential side toward the inner circumferential side as shown in FIG. 22 by way of example. In addition, each of the grooves 163b is formed to become gradually shallower from the outer circumferential side toward the inner circumferential side as shown in FIG. 23 by way of example. Each of the grooves 163b is formed so that its lengthwise direction extends along the radius direction of rotation. According to this configuration, surface tension which acts on the balancer becomes gradually larger from the outer circumferential side toward the inner circumferential side, whereby the balancer can easily return to the holding member 117 on the inner circumferential side when the rotation speed of the housing member 163 is reduced.

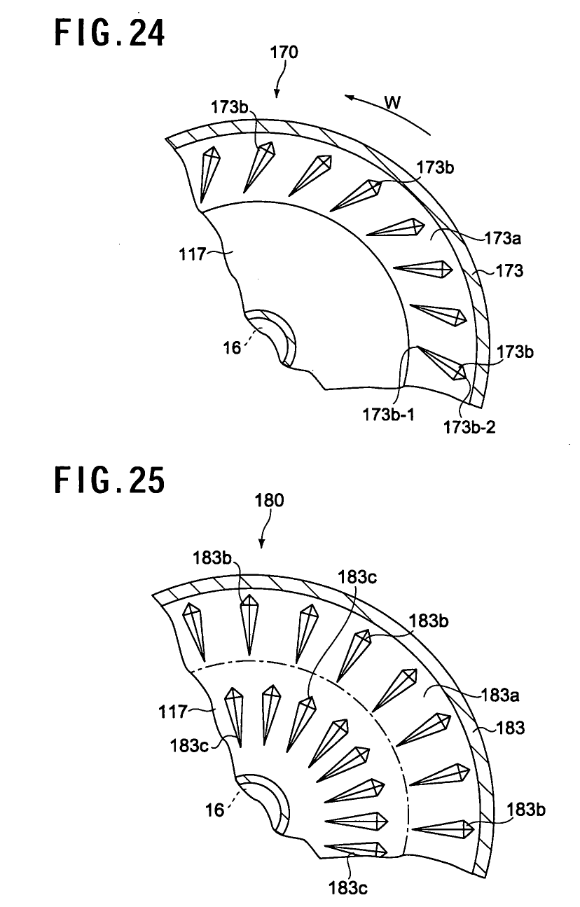

FIG. 24 is across-sectional view showing a modification of the automatic balancing apparatus 160 shown in FIG. 22. In an automatic balancing apparatus 170, a plurality of grooves 173b are formed in a bottom surface 173a of a housing member 173 on the outer circumferential side thereof so that each of the grooves 173b is formed so that its lengthwise direction extends along the radius direction of rotation. Specifically, each of the grooves 173b is formed to extend in a direction in which one end 173b-1 located on the inner circumferential side can move in advance of another end 173b-2 located on the outer circumferential side while the housing member 173 rotates in the rotation direction W. When the rotation speed of the housing member 173 is reduced, for example, the balancer accumulated on the outer circumferential side tries to move by inertia in the rotation direction W, and in this modification, since the grooves 173b are formed to extend in a direction as close to the rotation direction W as possible, the balancer can be reliably returned to the holding member 117.

FIG. 25 is a cross-sectional view showing a modification of the automatic balancing apparatus 160 shown inn FIG. 22. In an automatic balancing apparatus 180, a plurality of grooves 183b are formed in a bottom surface 183a of a housing member 183, and further, a plurality of grooves 183c are formed on the inner circumferential side of the grooves 183b. The provision of the grooves 183c makes it possible to give holding force based on surface tension to the balancer held by the holding member 117.

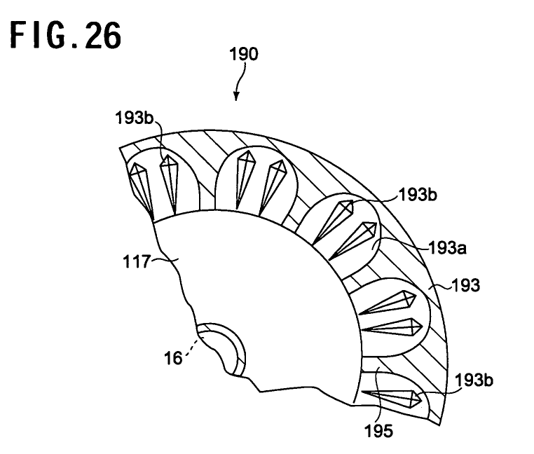

FIG. 26 is a cross-sectional view showing a modification of the automatic balancing apparatus 160 shown in FIG. 22. An automatic balancing apparatus 190 has a configuration in which the automatic balancing apparatus 120 shown in FIG. 18 is combined with the automatic balancing apparatus 160 shown in FIG. 22.

Specifically, in the section between each restrictive member 195 of a housing member 193, grooves 193b are formed in a bottom surface 193a of the housing member 193. According to this configuration as well, the balancer can be reliably returned to the holding member 117 when the rotation speed of the housing member 193 is reduced.

Each of FIGS. 22 to 26 shows a configuration in which the grooves 163b and so on are formed to become gradually thinner from the outer circumferential side toward the inner circumferential side, but grooves of constant width or depth may also be formed as the grooves 163b and so on. The grooves 163b and so on may be formed not only in the bottom surface 163a of the housing member 163 and so on, but also in a top surface opposed to the bottom surface 163a. The shapes of the grooves 163b and so one are not limited to the shown examples.

In addition, it is possible to combine at least two selected from among the automatic balancing apparatuses according to the first to eleventh preferred embodiments and the automatic balancing apparatuses according to the modifications.

While in each of the above-mentioned preferred embodiments, reference has been made to a configuration which holds the balancer by means of the holding member 17 which generates surface tension, for example. However, the holding member 17 may not be used, and a permanent magnet may also be provided on the inner circumferential side of a housing member so as to hold the balancer. The housing member constructed to hold the balancer not by surface tension but by the permanent magnet can further be provided with the restrictive members 15 shown in FIG. 4. The housing member constructed to hold the balancer by the permanent magnet may also have a configuration such as that shown in any of FIGS. 17 to 26.

What is claimed is:

1. An automatic balancing apparatus comprising:
a fluid balancer;
a holding member for holding the balancer by generating a surface tension on the balancer; and
a rotatably provided housing member housing the balancer and the holding member so that the balancer held by the holding member on its inner circumferential side moves toward an outer circumferential side of the housing member by centrifugal force caused by rotation.

2. The automatic balancing apparatus according to claim 1, further comprising a restrictive member provided on the outer circumferential side of the housing member for restricting movement of the balancer in a circumferential direction when the housing member rotates.

3. The automatic balancing apparatus according to claim 1, wherein the holding member comprises a plurality of plates provided stacked at an interval on an axial direction of rotation.

4. The automatic balancing apparatus according to claim 1, wherein the holding member forms a flow path provided to be narrower from the outer circumferential side toward the inner circumferential side and through which the balancer flows.

5. The automatic balancing apparatus according to claim 4, wherein the flow path is formed to have a width in a rotation axis direction to which the housing member rotates, the width formed to be narrower from the outer circumferential side toward the inner circumferential side.

6. The automatic balancing apparatus according to claim 4, wherein the flow path is formed to have a width in a rotation circumferential direction to which the housing member rotates, the width formed to be narrower from the outer circumferential side toward the inner circumferential side.

7. The automatic balancing apparatus according to claim 1, further comprising a permanent magnet provided on the inner circumferential side of the housing member, wherein the balancer is a magnetic fluid.

8. The automatic balancing apparatus according to claim 1, wherein the holding member comprises a surface having a plurality of projections thereon.

9. The automatic balancing apparatus according to claim 8, wherein the projections are provided to have a surface area that gradually increases from the outer circumferential side toward the inner circumferential side of the holding member.

10. The automatic balancing apparatus according to claim 1, wherein:
the holding member includes:
a first surface;
a first plate having a plurality of first projections projecting from the first surface;
a second surface opposed to the first surface;
and
a second plate including a plurality of second projections provided to project from the second surface toward the first surface, and to overlap with the first projections along their own projecting direction.

11. The automatic balancing apparatus according to claim 1, wherein:
the holding member includes:
a surface approximately perpendicular to the rotation axis direction provided in its interior;
a lateral surface provided on the outer circumferential side of the interior and approximately parallel to the rotation axis direction; and
a curved surface provided to extend from the surface to the curved surface.

12. The automatic balancing apparatus according to claim 1, wherein:
the holding member includes:
a top surface approximately perpendicular to the rotation axis direction provided in its interior;
a bottom surface provided in the interior and opposed to the top surface; and
a curved surface provided on the outer circumferential side to extend from the top surface toward the bottom surface.

13. The automatic balancing apparatus according to claim 2, wherein:
the restrictive member includes a restrictive surface approximately parallel with the rotation axis direction of the holding member; and
the holding member has:
a lateral surface provided on the outer circumferential side; and
a curved surface provided to extend from the restrictive surface to the lateral surface.

14. The automatic balancing apparatus according to claim 1, wherein:
the holding member includes:
a surface approximately perpendicular to a rotation axis direction provided in its interior;
a lateral surface approximately parallel with the rotation axis direction provided on the outer circumferential side of the interior of the holding member; and
an inclined surface provided to extend from the surface to the lateral surface so that the internal volume of the housing member gradually decreases from the inner circumferential side toward the outer circumferential side.

15. The automatic balancing apparatus according to claim 1, wherein the holding member includes a plurality of grooves formed to extend from the outer circumferential side toward the inner circumferential side.

16. The automatic balancing apparatus according to claim 15, wherein at least one of the grooves is provided to become gradually thinner from the outer circumferential side toward the inner circumferential side.

17. The automatic balancing apparatus according to claim 15, wherein at least one of the grooves extends in a direction different from the rotation radius direction of the holding member.

18. The automatic balancing apparatus according to claim 1, wherein the grooves are provided on the outer circumferential side in relation to the holding member.

19. The automatic balancing apparatus according to claim 1, wherein the holding member and the restrictive member are in abutment with each other.

20. A rotative apparatus comprising
a fluid balancer;
a holding member for holding the balancer by generating a surface tension on the balancer; and
a housing member for housing the balancer and the holding member; and
a driver capable of rotating the housing member integrally with the holding member so that the balancer held by the holding member on an inner circumferential side of the housing member moves toward an outer circumferential side of the housing member by centrifugal force caused by rotation.

21. A disc drive apparatus comprising:
a driver for rotationally driving a data-recordable disc; and
an automatic balancing apparatus including:
a fluid balancer;
a holding member for holding the balancer by generating a surface tension on the balancer; and
a rotatably provided housing member housing the balancer and the holding member so that the balancer held by the holding member on its inner circumferential side moves toward an outer circumferential side of the housing member by centrifugal force caused by rotation.
